(19) United States
(12) Patent Application Publication
(10) Pub. No.: US 2004/0192220 A1
(43) Pub. Date: Sep. 30, 2004

(54) Mechanism for switching cellular phone to digital camera

(75) Inventors: Jeng-Wen Huang, Taipei Hsien (TW); Jung-Kuan Tseng, Taipei Hsien (TW)

Correspondence Address: BACON & THOMAS, PLLC, 625 SLATERS LANE, FOURTH FLOOR, ALEXANDRIA, VA, 22314

(73) Assignee: Inventec Appliances Corp., Taipei Hsien (TW)

(21) Appl. No.: 10/394,252

(22) Filed: Mar. 24, 2003

(51) Int. Cl. H04M 1/00; H04B 1/40

(52) U.S. Cl. 455/74; 455/556.1

(57) ABSTRACT

The present invention is to provide a mechanism for switching a foldable cellular phone to a digital camera comprising a rotation member pivotally coupled between a display and a keypad thereof enabling the display to rotate 180 degrees and folded onto the keypad by a back of the display, wherein an image capture element being electrically connected to a control circuit thereof is provided on the back of the keypad, a magnet is provided at a side of the display; and a reed switch is provided on the keypad. Therefore, after the display being rotated 180 degrees and folded onto the keypad, the first reed switch is aligned with the magnet and switches the cellular phone to a camera mode, enabling the image capture element to take an image of an object.

### FIELD OF THE INVENTION

The present invention relates to cellular phones and more particularly to a mechanism for switching a cellular phone to function as a digital camera.

### BACKGROUND OF THE INVENTION

Increasingly, cellular phones gain popularity among people due to compactness, multi-function, and inexpensiveness. A person can efficiently communicates with a friend or client by means of cellular phone. As compared with a conventional wire telephone, the cellular phone can provide a more fast and convenient communication service.

Conventionally, a foldable cellular phone capable of taking pictures has its image capture element (such as a CCD) and display provided on the same surface. An image of a cellular phone user taken by the image capture element can be shown on the display for being previewed by the user. Unfortunately, an image of an object or another person taken by the image capture element and shown on the display cannot be viewed by the user at the same time while taking the picture since, as stated above, the image capture element and the display of the cellular phone are one the same surface. As such, the user cannot precisely adjust the image capture element to focus the desired image. This is very inconvenient. To the worse, the taken pictures are often poor in quality. Thus, continuing improvements in the exploitation of cellular phone are constantly being sought by electronic product manufacturers.

### SUMMARY OF THE INVENTION

A primary object of the present invention is to provide a mechanism for switching a foldable cellular phone to a digital camera. By utilizing this, the above drawback of the prior art can be overcome. The drawback is that an image of an object or another person taken by an image capture element cannot be shown on a display and viewed by a user at the same time. As such, the user cannot precisely adjust the image capture element to focus the desired image, resulting in a poor photograph.

One object of the present invention is to provide a mechanism for switching a foldable cellular phone to a digital camera. The mechanism comprises a rotation member pivotally coupled between a display and a keypad of the cellular phone so that the display can be opened to the position of the same horizontal surface as the keypad and be folded onto the keypad to close the cellular phone, or being rotated 180 degrees and folded onto the keypad by a back of the display; an image capture element provided at a side on the back of the keypad, the image capture element being electrically connected to a control circuit of the cellular phone; a magnet provided at a side of the display; and a first reed switch provided on the keypad at a position corresponding to the magnet. After the display being rotated 180 degrees and folded onto the keypad by the back of the display, the magnet is aligned with and magnetically attracts the first reed switch being electrically connected to the control circuit, in response the control circuit is enabled to switch the cellular phone to a camera mode. Therefore, the image capture element is at the back of the keypad, and the display is on the front of the cellular phone so that the image capture element is operative to take an image of an object, the image of the object is shown on a screen of the display for being previewed, and a button of the cellular phone served as a release button of camera is operative to press for taking a photograph.

Another object of the present invention is to further provide a second reed switch on a front surface of the keypad corresponding to the magnet, the second reed switch being electrically connected to the control circuit of the cellular phone. In switching the control circuit from the camera mode to a cellular phone mode, lifting the display to its full open position prior to rotating the display back to its original position facing and folded onto the keypad until the magnet is aligned with and magnetically attracts the second reed switch, thereby enabling the control circuit to switch back to the cellular phone mode for functioning as a telephone.

The above and other objects, features and advantages of the present invention will become apparent from the following detailed description taken with the accompanying drawings.

### BRIEF DESCRIPTION OF THE DRAWINGS

FIG. 1 is a top plan view of a cellular phone in an open state according to the invention;

FIG. 2 is a perspective view of the cellular phone illustrating a rotation of display shown in dash lines;

FIG. 3 is a perspective view of the cellular phone being in a camera mode;

FIG. 4 is a circuit diagram of the cellular phone of the invention; and

FIG. 5 is another circuit diagram the cellular phone of the invention.

### DETAILED DESCRIPTION OF THE PREFERRED EMBODIMENTS

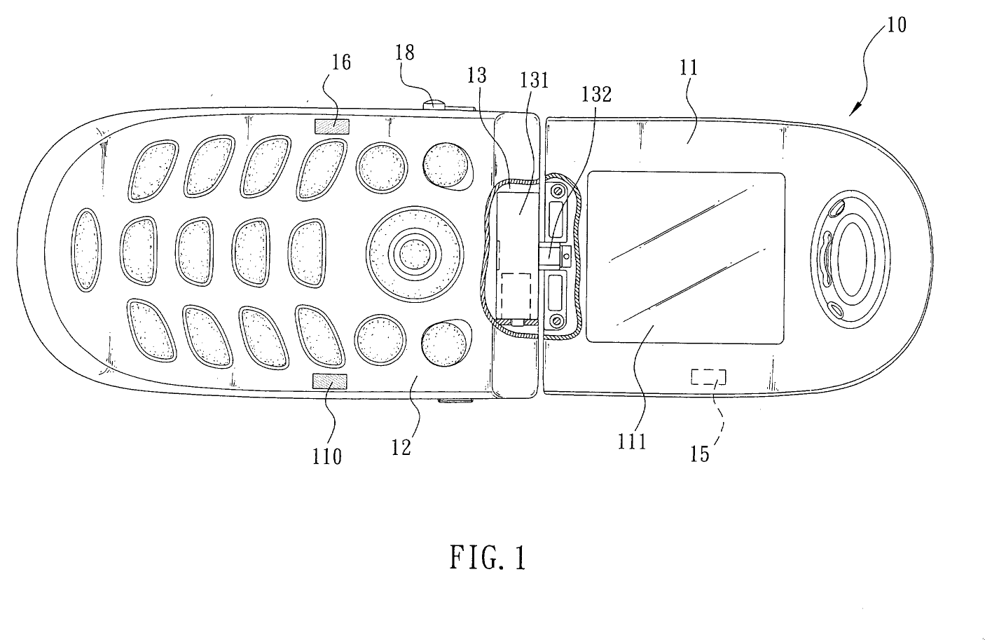

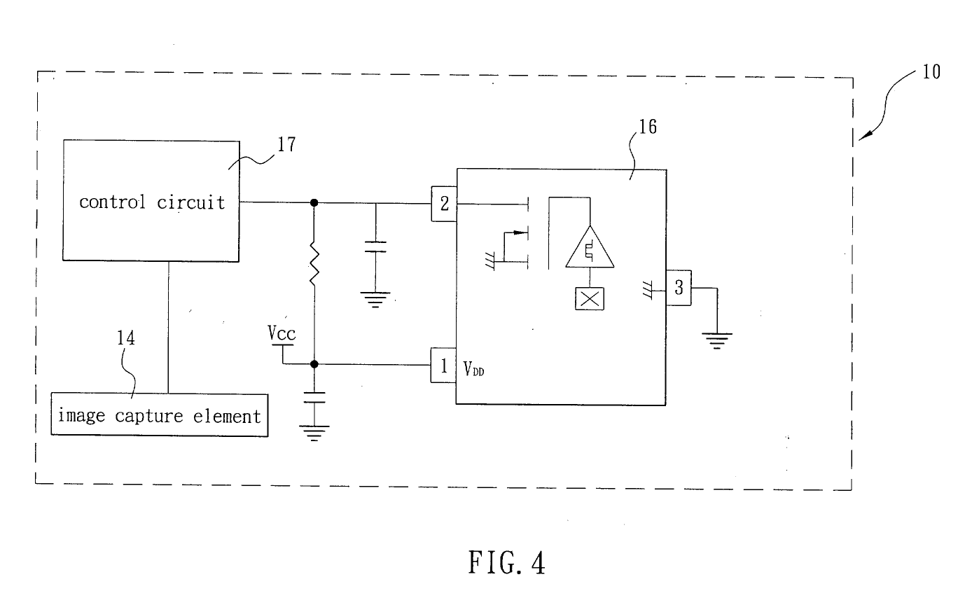

Referring to FIGS. 1, 2, and 3, there is shown a mechanism for switching a foldable generally parallelepiped cellular phone 10 to a digital camera in accordance with the invention comprising a rotation member 13 pivotally coupled between a display 11 and a keypad 12 of the cellular phone 10. Hence, the display 11 can be folded to rest onto the keypad 12 in a close state and be opened to the position of the same horizontal surface as the keypad 12. In an open state, the display 11 can be rotated 180 degrees and folded back onto the keypad 12 by a back of the display 11. An image capture element 14 is provided at a side on a back of the keypad 12 of the cellular phone 10. The image capture element 14 is electrically connected to a control circuit 17 of the cellular phone 10 (see FIG. 4). Further, at least one magnet 15 is provided at a side of the display 11. After the display 11 being rotated 180 degrees and folded onto the keypad 12, a first reed switch 16 provided on the first position of the front surface of the keypad 12 is aligned with the magnet 15. The first reed switch 16 is electrically connected to the control circuit 17 of the cellular phone 10 (see FIG. 4).

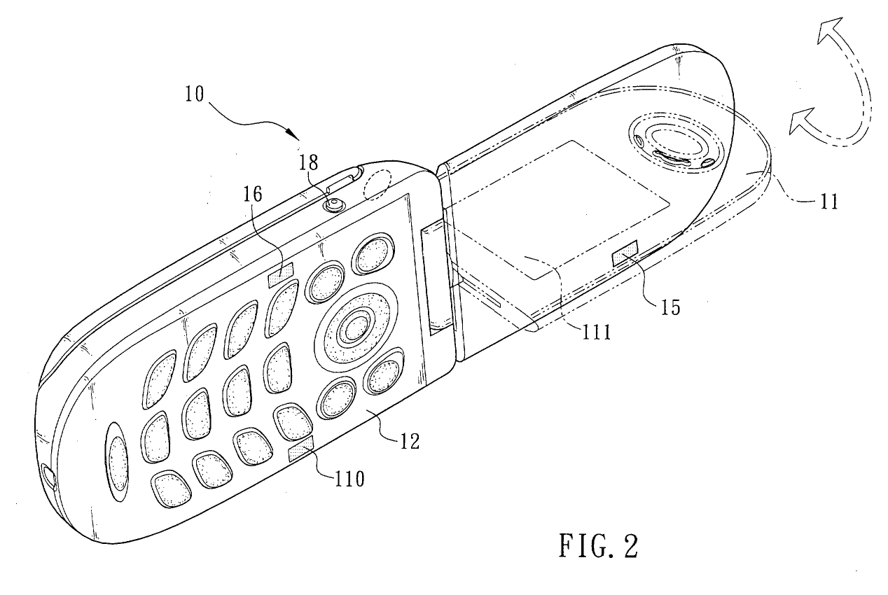

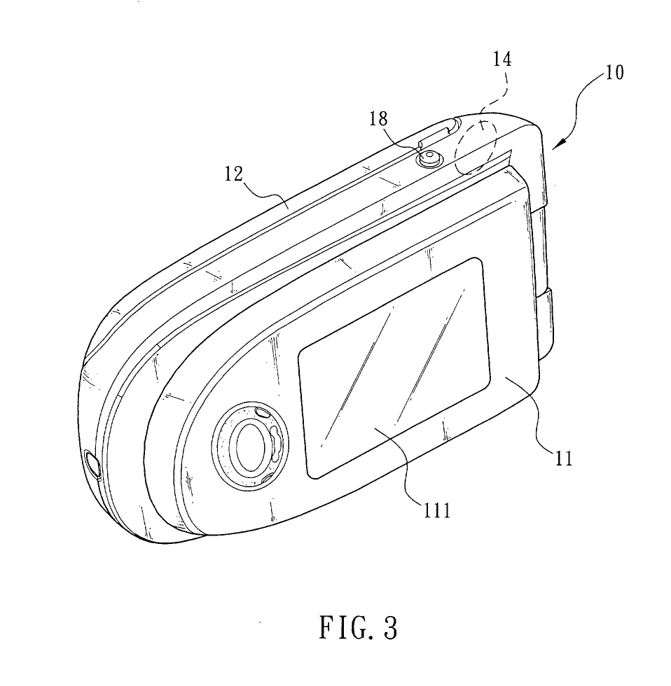

Referring to FIGS. 2 and 3 again, when the magnet 15 is aligned with and magnetically attracts the first reed switch 16 after the display 11 has been rotated 180 degrees and folded back onto the keypad 12 by the back of the display 11, the first reed switch 16 will be activated and enable the control circuit 17 to switch the cellular phone 10 to a camera mode (see FIGS. 1 and 4). At this moment, the image capture element 14 located at the back of the keypad 12 is on the opposite direction to the display 11. Hence, a user can use the cellular phone 10 as a digital camera for taking an image of an object (or person) by means of the image capture element 14. Further, the image of the object (or person) taken by the image capture element 14 can be shown on a screen 111 of the display 11 for being previewed by the user. While taking the image, the user can press a button 18 provided on the cellular phone 10 served as a release button of typical camera for taking a picture.

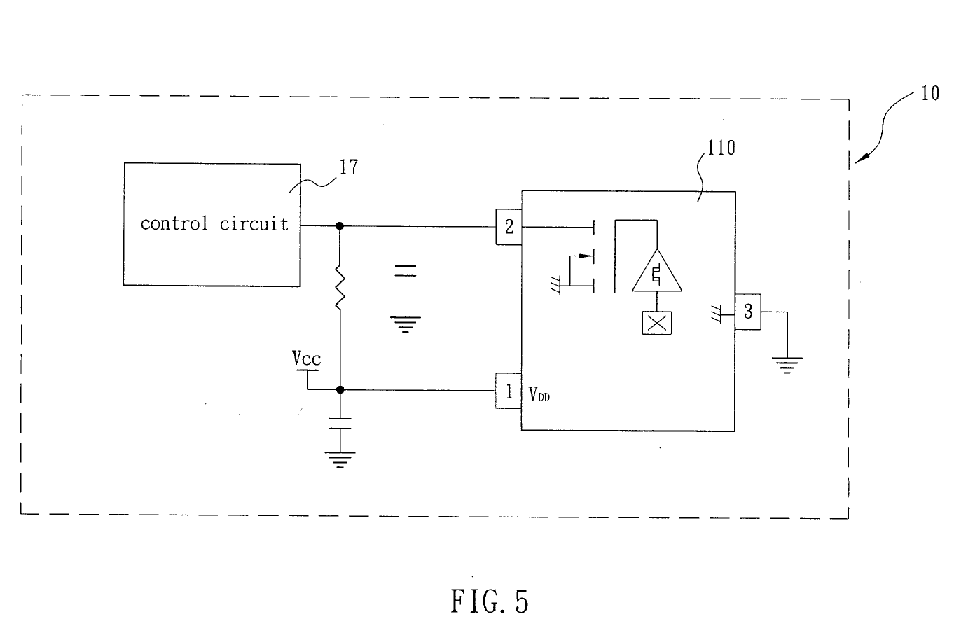

Referring to FIGS. 1 and 5, in the invention there is a second reed switch 110 provided on the second position of the front surface of the keypad 12, the second reed switch 110 is aligned with and magnetically attracted by the magnet 15 after the display 11 has been folded back to the original position resting on the keypad 12 by the front of the display 11. At this moment the second reed switch 110 will be activated and enable the control circuit 17 to switch the cellular phone 10 back to a camera mode (see FIGS. 1 and 4). Following is a description of switching the control circuit 17 from the camera mode to a default cellular phone mode. First, user can lift the display 11 to its full open position, and then rotate the display 11 180 degrees and fold the display 11 back onto the keypad 12 by the frond of the display 11. When the front of the display 11 is rested onto the keypad 12, the magnet 15 is aligned with and magnetically attracts the second reed switch 110. As a result, the control circuit 17 is enabled to switch the cellular phone back to the mode functioning as a typical cellular phone. Hence, the user can use the cellular phone 10 to make a call.

Referring to FIGS. 1 and 4 again, in the invention pin 2, pin 1, and pin 3 of the first reed switch 16 are connected to the control circuit 17, a supply voltage Vcc of the cellular phone 107 and a ground of the cellular phone 10 respectively. At this time, power of the supply voltage Vcc is fed to the control circuit 17 via the first reed switch 16 for maintaining the control circuit 17 at a logic high level. Alternatively, the first reed switch 16 is open when the magnet 15 magnetically attracts the first reed switch 16. As such, power of the supply voltage Vcc cannot feed to the control circuit 17 via the first reed switch 16. As an end, the control circuit 17 is enabled by a logic low level of the supply voltage Vcc and thus is switched to the camera mode.

Referring to FIGS. 1 and 5 again, in the invention pin 2, pin 1, and pin 3 of the second reed switch 110 are connected to the control circuit 17, the supply voltage Vcc of the cellular phone 10, and the ground of the cellular phone 10 respectively. At this time, power of the supply voltage Vcc is fed to the control circuit 17 via the second reed switch 110 for maintaining the control circuit 17 at a logic high level. Alternatively, the second reed switch 110 is open when the magnet 15 magnetically attracts the second reed switch 110. As such, power of the supply voltage Vcc cannot feed to the control circuit 17 via the second reed switch 110. As an end, the control circuit 17 is enabled by the logic low level of the supply voltage Vcc and thus is switched to the cellular phone mode.

Referring to FIGS. 2, 3, and 4 again, in the invention the image capture element 14 can be controlled by the control circuit 17 to fetch an image of object to be taken when the control circuit 17 is at the camera mode. Further, the image is shown on the screen 111 of the display 11 for preview. At the same time, the user can press the button 18 for causing the control circuit 17 to store the image taken by the image capture element 14 in a memory of the cellular phone 10.

Referring to FIG. 1 again, in the invention the rotation member 13 comprises a connection section 131 and a pivot pin 132. The pivot pin 132 is rotatably connected to the connection section 131 so that the pivot pin 132 is able to rotate about the connection section 131. The pivot pin 132 is rotatably connected to the display 11. Two ends of the connection section 131 are inserted into and are pivotal about the keypad 12. As an end, the display 11 can be not only folded onto the keypad 12 but also rotated 180 degrees about the keypad 12 and folded onto keypad 12 by the back of the display 11.

While the invention has been described by means of specific embodiments, numerous modifications and variations could be made thereto by those skilled in the art without departing from the scope and spirit of the invention set forth in the claims.

What is claimed is:

1. A mechanism for switching a foldable cellular phone to a digital camera, comprising:
a rotation member pivotally coupled between a display and a keypad of the cellular phone, wherein the display can be opened to the position of the same horizontal surface as the keypad and be folded onto the keypad to close the cellular phone, or being rotated 180 degrees and folded onto the keypad by a back surface of the display;
an image capture element provided at a side on a back surface of the keypad of the cellular phone, the image capture element being electrically connected to a control circuit of the cellular phone;
a magnet provided at a side on the display; and
a first reed switch provided on the keypad, the first reed switch being disposed on the keypad at a position corresponding to the magnet and being electrically connected to the control circuit of the cellular phone;
wherein, while the display being rotated 180 degrees and folded onto the keypad by the back surface of the display, the magnet is aligned with and magnetically attracts the first reed switch, in response the control circuit is enabled to switch to a camera mode, so that the image capture element is operative to take an image of an object and shows the image of the object on a screen of the display for being previewed.

2. The mechanism of claim 1, further comprising a button of the cellular phone served as a release button of camera is operative to press for taking a photograph.

3. The mechanism of claim 1, further comprising a second reed switch on a front surface of the keypad corresponding to the magnet, the second reed switch being electrically connected to the control circuit of the cellular phone, wherein while the display being rotated to a position facing and folded onto the keypad, the magnet is aligned with and magnetically attracts the second reed switch, thereby enabling the control circuit to switch the cellular phone back to a mode functioning as a telephone.

4. The mechanism of claim 1, wherein a second pin, a first pin, and a third pin of the first reed switch are connected to the control circuit, a supply voltage of the cellular phone, and a ground of the cellular phone respectively, so that the first reed switch is opened when the magnet magnetically attracts the first reed switch for preventing the power of the supply voltage from feeding to the control circuit via the first reed switch, thereby activating the control circuit by a logic low level of the supply voltage and enabling the control circuit to switch to the camera mode.

5. The mechanism of claim 1, wherein a second pin, a first pin, and a third pin of the second reed switch are connected to the control circuit, the supply voltage of the cellular phone, and the ground of the cellular phone respectively so that the second reed switch is opened when the magnet magnetically attracts the second reed switch for preventing the power of the supply voltage from feeding to the control circuit via the second reed switch, thereby activating the control circuit by the logic low level of the supply voltage and enabling the control circuit to switch to the cellular phone mode.

6. The mechanism of claim 1, wherein a rotation member comprises a connection section having two ends inserted into and pivotal about the keypad and a pivot pin having one end rotatably connected to and being rotatable about the connection section and the other end rotatably connected to the display so that the display is operative to not only fold onto the keypad but also rotate 180 degrees about the keypad to the back of the cellular phone.
